(19) United States
(12) Patent Application Publication
(10) Pub. No.: US 2008/0053488 A1
(43) Pub. Date: Mar. 6, 2008

(54) SUBSTRATE TREATMENT APPARATUS AND SUBSTRATE TREATMENT METHOD

(76) Inventor: Hiroaki Uchida, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/848,369

(22) Filed: Aug. 31, 2007

(30) Foreign Application Priority Data
Aug. 31, 2006 (JP) 2006-235016

(51) Int. Cl. B08B 7/04; B08B 3/00

(52) U.S. Cl. 134/32; 134/137

(57) ABSTRACT

A substrate treatment apparatus according to the present invention includes: a substrate holding unit which holds a substrate; a push-pull plate to be positioned in spaced opposed relation to one surface of the substrate held by the substrate holding unit, the push-pull plate having a plurality of outlet ports which discharge a treatment liquid and a plurality of suction ports which suck the treatment liquid discharged from the outlet ports, the outlet ports and the suction ports being provided in a surface of the push-pull plate to be opposed to the one surface of the substrate; and a relative rotation unit which rotates the substrate held by the substrate holding unit and the push-pull plate relative to each other.

### BACKGROUND OF THE INVENTION

1. Field of the Invention

The present invention relates to a substrate treatment apparatus and a substrate treatment method to be employed for treating a substrate with a treatment liquid. Examples of the substrate to be treated include semiconductor wafers, glass substrates for liquid crystal display devices, glass substrates for plasma display devices, glass substrates for FED (Field Emission Display) devices, substrates for optical disks, substrates for magnetic disks, substrates for magneto-optical disks, substrates for photo masks and ceramic substrates.

2. Description of the Related Art

In production processes for semiconductor devices and liquid crystal display devices, a surface of a substrate such as a semiconductor wafer or a glass substrate for a liquid crystal display panel is generally treated with a treatment liquid for cleaning by supplying the treatment liquid to the substrate surface.

An apparatus of a single substrate treatment type adapted to treat substrates one by one for cleaning, for example, includes a spin chuck which rotates a substrate while holding the substrate generally horizontally, and a nozzle which sprays a chemical agent over a surface of the substrate rotated by the spin chuck. During the treatment, the chemical agent is sprayed from the nozzle on the substrate surface around the rotation center of the substrate, while the substrate is rotated by the spin chuck. The chemical agent supplied onto the substrate surface receives a centrifugal force generated by the rotation of the substrate, thereby flowing toward a peripheral edge of the substrate on the substrate surface. Thus, the chemical agent spreads over the entire substrate surface, whereby a cleaning process is performed to clean the substrate surface with the chemical agent (see, for example, Japanese Unexamined Patent Publication (KOKAI) No. 10-172950 (1998)).

However, the chemical agent sprayed on the rotating substrate from the nozzle is liable to be scattered around the substrate. The scattered chemical agent adheres to components disposed around the spin chuck, and is dried to be crystallized. The resulting crystals of the chemical agent are disintegrated into particles, which contaminate the substrate.

### SUMMARY OF THE INVENTION

It is therefore an object of the present invention to provide a substrate treatment apparatus and a substrate treatment method which ensure proper treatment of a substrate with a treatment liquid, while suppressing the scattering of the treatment liquid around the substrate.

A substrate treatment apparatus according to the present invention includes: a substrate holding unit which holds a substrate; a push-pull plate to be positioned in spaced opposed relation to one surface of the substrate held by the substrate holding unit, the push-pull plate having a plurality of outlet ports which discharge a treatment liquid and a plurality of suction ports which suck the treatment liquid discharged from the outlet ports, the outlet ports and the suction ports being provided in a surface of the push-pull plate to be opposed to the one surface of the substrate; and a relative rotation unit which rotates the substrate held by the substrate holding unit and the push-pull plate relative to each other.

A substrate treatment method according to the present invention includes the steps of: holding a substrate by a substrate holding unit; positioning a push-pull plate in spaced opposed relation to one surface of the substrate held by the substrate holding unit, the push-pull plate having a plurality of outlet ports which discharge a treatment liquid and a plurality of suction ports which suck the treatment liquid discharged from the outlet ports, and bringing the treatment liquid discharged from the outlet ports into contact with the one surface of the substrate; and rotating the substrate and the push-pull plate relative to each other in the liquid contacting step.

With this arrangement, the treatment liquid is discharged toward the one surface of the substrate from the outlet ports provided on the push-pull plate, and sucked from the suction ports provided on the push-pull plate. Thus, a film of the treatment liquid is formed on the push-pull plate. Then, the treatment liquid film is brought into contact with the one surface of the substrate with the push-pull plate being positioned in opposed relation to the one surface of the substrate, whereby the one surface of the substrate is treated with the treatment liquid. Since the treatment liquid discharged from the outlet ports of the push-pull plate is sucked from the suction ports immediately after the discharge, the treatment liquid is not scattered around the substrate. This ensures proper treatment of the substrate with the treatment liquid, while suppressing the scattering of the treatment liquid around the substrate.

Since the push-pull plate and the substrate are rotated relative to each other, the treatment liquid is evenly brought into contact with the entire one surface of the substrate. Thus, the one surface of the substrate is evenly treated with the treatment liquid.

The relative rotation unit may rotate the substrate held by the substrate holding unit about an axis extending through the center of the substrate.

The foregoing and other objects, features and effects of the present invention will become more apparent from the following description of the preferred embodiments with reference to the attached drawings.

### BRIEF DESCRIPTION OF THE DRAWINGS

FIG. 1 is a sectional view schematically illustrating the construction of a substrate treatment apparatus according to one embodiment of the present invention; and

FIG. 2 is a bottom view illustrating a lower surface of a push-pull plate.

### DETAILED DESCRIPTION OF PREFERRED EMBODIMENTS

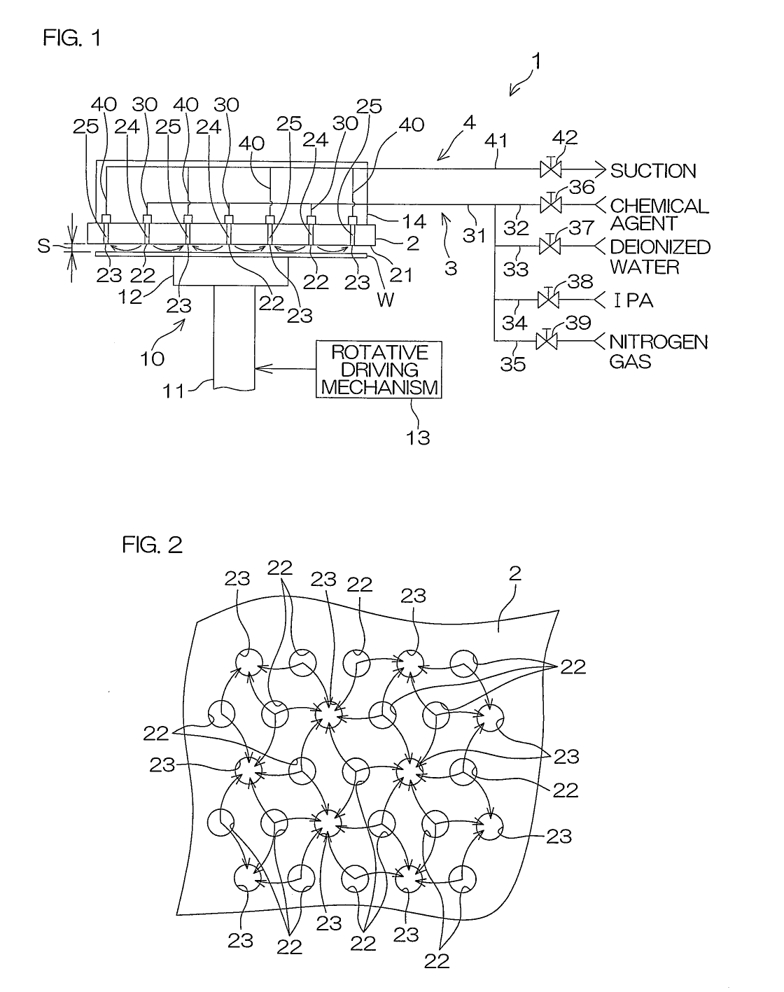

FIG. 1 is a sectional view schematically illustrating the construction of a substrate treatment apparatus according to one embodiment of the present invention.

The substrate treatment apparatus 1 is an apparatus of a single substrate treatment type for treating a front surface (upper surface) of a semiconductor wafer W (an example of a substrate hereinafter referred to simply as “wafer”) having a device formation region with a treatment liquid. The substrate treatment apparatus 1 includes a spin chuck 10 which holds the wafer W generally horizontally and rotates the wafer W, and a push-pull plate 2 which treats the front surface of the wafer W held by the spin chuck 10 with the treatment liquid. A chemical agent, deionized water and the like are used as the treatment liquid for the treatment of the front surface of the wafer W.

The spin chuck 10 is, for example, a chuck of a vacuum suction type. The spin chuck 10 includes a spin shaft 11 extending generally vertically, and a suction base 12 attached to an upper end of the spin shaft 11 and adapted to suck a rear surface (lower surface) of the wafer W to hold the wafer W generally horizontally. A rotative driving mechanism 13 such as including a motor is coupled to the spin shaft 11. With the wafer W being held on the suction base 12 by suction, a driving force is inputted to the spin shaft 11 from the rotative driving mechanism 13. Thus, the wafer W is rotated about a center axis of the spin shaft 11 extending through the center of the wafer W, while being held generally horizontally.

The push-pull plate 2 has a disk shape having a greater diameter than the wafer W. The push-pull plate 2 is fixed to a lower surface of a support block 14 supported by an arm not shown. The push-pull plate 2 can be positioned in opposed relation to the wafer W held by the spin chuck 10 as being spaced a predetermined distance S from the wafer W. The push-pull plate 2 includes a plurality of outlet ports 22 and a plurality of suction ports 23 provided in a lower surface 21 thereof. The push-pull plate 2 further includes generally cylindrical supply paths 24 respectively communicating with the outlet ports 22, and generally cylindrical suction paths 25 respectively communicating with the suction ports 23. The supply paths 24 and the suction paths 25 each extend through the push-pull plate 2 along the thickness of the push-pull plate 2 (vertically).

A chemical agent, deionized water, IPA (isopropyl alcohol) and nitrogen gas are selective supplied to the outlet ports 22 of the push-pull plate 2 by a supply mechanism 3. Hydrofluoric acid, for example, is employed as the chemical agent but, instead, SPM (sulfuric acid/hydrogen peroxide mixture), SC1 (ammonia-hydrogen peroxide mixture) or SC2 (hydrochloric acid/hydrogen peroxide mixture) may be employed as the chemical agent. Ultrasonic vibrations may be applied to any of these chemical agents. The chemical agent, the deionized water, the IPA or the nitrogen gas discharged from the outlet ports 22 is sucked into the suction ports 23 of the push-pull plate 2 by a suction mechanism 4.

The supply mechanism 3 includes supply pipe branches 30 each having one end connected to the corresponding supply path 24, and a central supply pipe 31 connected commonly to the other ends of the respective supply pipe branches 30. The supply pipe branches 30 are provided in the support block 14. The central supply pipe 31 extends out of the support block 14. Outside the support block 14, a chemical agent supply pipe 32, a deionized water supply pipe 33, an IPA supply pipe 34 and a nitrogen gas supply pipe 35 are connected to the central supply pipe 31.

The chemical agent is supplied to the chemical agent supply pipe 32 from a chemical agent tank not shown. A chemical agent valve 36 which opens and closes the chemical agent supply pipe 32 is provided in the middle of the chemical agent supply pipe 32. The deionized water is supplied to the deionized water supply pipe 33 from a deionized water supply source not shown. A deionized water valve 37 which opens and closes the deionized water supply pipe 33 is provided in the middle of the deionized water supply pipe 33. The IPA is supplied to the IPA supply pipe 34 from an IPA supply source not shown. An IPA valve 38 which opens and closes the IPA supply pipe 34 is provided in the middle of the IPA supply pipe 34. The nitrogen gas is supplied to the nitrogen gas supply pipe 35 from a nitrogen gas supply source not shown. A nitrogen gas valve 39 which opens and closes the nitrogen gas supply pipe 35 is provided in the middle of the nitrogen gas supply pipe 35.

With the deionized water valve 37, the IPA valve 38 and the nitrogen gas valve 39 being closed and with the chemical agent valve 36 being opened, the chemical agent contained in the chemical agent tank not shown is supplied to the outlet ports 22 through the chemical agent supply pipe 32, the central supply pipe 31, the supply pipe branches 30 and the supply paths 24. With the chemical agent valve 36, the IPA valve 38 and the nitrogen gas valve 39 being closed and with the deionized water valve 37 being opened, the deionized water contained in the deionized water supply source not shown is supplied to the outlet ports 22 through the deionized water supply pipe 33, the central supply pipe 31, the supply pipe branches 30 and the supply paths 24. With the chemical agent valve 36, the deionized water valve 37 and the nitrogen gas valve 39 being closed and with the IPA valve 38 being opened, the IPA contained in the IPA supply source not shown is supplied to the outlet ports 22 through the IPA supply pipe 34, the central supply pipe 31, the supply pipe branches 30 and the supply paths 24. With the chemical agent valve 36, the deionized water valve 37 and the IPA valve 38 being closed and with the nitrogen gas valve 39 being opened, the nitrogen gas contained in the nitrogen gas supply source not shown is supplied to the outlet ports 22 through the nitrogen gas supply pipe 35, the central supply pipe 31, the supply pipe branches 30 and the supply paths 24.

The suction mechanism 4 includes suction pipe branches 40 each having one end connected to the corresponding suction path 25, and a central suction pipe 41 connected commonly to the other ends of the respective suction pipe branches 40. The suction pipe branches 40 are provided in the support block 14. The central suction pipe 41 extends out of the support block 14. An end of the central suction pipe 41 is connected to a suction device (not shown) which evacuates the central suction pipe 41 by vacuum. A suction valve 42 which opens and closes the central suction pipe 41 is provided in the middle of the central suction pipe 41.

With the chemical agent, the deionized water, the IPA or the nitrogen gas being discharged from the outlet ports 22 of the push-pull plate 2, the suction valve 42 is opened. Thus, the chemical agent, the deionized water, the IPA or the nitrogen gas discharged from the outlet ports 22 is sucked from the suction ports 23 of the push-pull plate 2.

FIG. 2 is a bottom view illustrating the lower surface of the push-pull plate. In the lower surface 21 of the push-pull plate 2, the suction ports 23 are arranged, for example, in a combination of two different matrix arrays. That is, suction ports 23 of a first group are equidistantly arranged in two orthogonal directions in a first matrix array, and suction ports 23 of a second group are arranged in a second matrix array such as to be spaced from one another by a distance equivalent to an inter-column or inter-row spacing of the first matrix array and staggered from the suction ports 23 of the first group by a distance equivalent to one half the inter-column or inter-row spacing. The outlet ports 22 are arranged such that six outlet ports 22 are located around each suction port 23 at vertices of a regular hexagon centering on that suction port 23. Thus, streams of the chemical agent, the deionized water, the IPA or the nitrogen gas discharged from the six outlet ports 22 flow collectively into the suction port 23 located at the center of the hexagon defined by the six outlet ports 22 as indicated by arrows in FIG. 2.

Referring again to FIG. 1, how the substrate treatment apparatus 1 treats the wafer W will be described.

For the treatment of the wafer W, the wafer W is first loaded into the substrate treatment apparatus 1 by a transport robot not shown, and held by the spin chuck 10. Thereafter, the push-pull plate 2 is positioned in opposed relation to the front surface of the wafer W as being spaced the predetermined distance S from the front surface of the wafer W. Then, the rotative driving mechanism 13 of the spin chuck 10 starts rotating the suction base 12 together with the wafer W about the center axis of the spin shaft 11.

In a cleaning process employing the chemical agent, the chemical agent is discharged from the outlet ports 22 of the push-pull plate 2 and the discharged chemical agent is sucked from the suction ports 23, while the wafer W is kept rotated at a predetermined rotation speed (e.g., 500 rpm). The chemical agent discharged from the outlet ports 22 located around the suction ports 23 is sucked from the suction ports 23 immediately after the discharge. Thus, a film of the chemical agent flowing from the outlet ports 22 to the suction ports 23 is formed on the lower surface 21 of the push-pull plate 2. The distance S between the lower surface 21 of the push-pull plate 2 and the front surface of the wafer W is set such as to be smaller than the thickness of the chemical agent film and, for example, set to 0.05 mm to 5 mm. Therefore, the chemical agent film is brought into contact with the front surface of the wafer W rotated relative to the push-pull plate 2. The chemical agent can be evenly supplied to the entire front surface of the wafer W by rotating the wafer W relative to the push-pull plate 2 with the front surface of the wafer W kept in contact with the chemical agent film retained on the lower surface 21 of the push-pull plate 2. Thus, the entire front surface of the wafer W is cleaned with the chemical agent.

After a lapse of a predetermined treatment period (e.g., 30 seconds) from the start of the cleaning process employing the chemical agent, the supply of the chemical agent from the outlet ports 22 of the push-pull plate 2 is stopped. Then, the deionized water is discharged from the outlet ports 22. The deionized water discharged from the outlet ports 22 is sucked from the suction ports 23, and then drained through the central suction pipe 41 into a drainage system not shown. The deionized water discharged from the outlet ports 22 located around the suction ports 23 is sucked from the suction ports 23 immediately after the discharge. Thus, a film of the deionized water flowing from the outlet ports 22 to the suction ports 23 is formed on the lower surface 21 of the push-pull plate 2. Then, the deionized water film is brought into contact with the front surface of the wafer W. The chemical agent adhering on the entire front surface of the wafer W is washed away with the deionized water by rotating the wafer W relative to the push-pull plate 2 with the deionized water film kept in contact with the front surface of the wafer W.

After a lapse of a predetermined rinsing period (e.g., 30 seconds) from the start of the discharge of the deionized water, the supply of the deionized water from the outlet ports 22 of the push-pull plate 2 is stopped. Thereafter, the rotative driving of the spin chuck 10 is stopped, whereby the rotation of the wafer W is stopped. After the wafer W stops still, the IPA is discharged from the outlet ports 22. At this time, the IPA discharged from the outlet ports 22 is sucked from the suction ports 23, and then drained through the central suction pipe 41 into a drainage system not shown. The IPA discharged from the outlet ports 22 located around the suction ports 23 are sucked from the suction ports 23 immediately after the discharge. Thus, a film of the IPA flowing from the outlet ports 22 to the suction ports 23 is formed on the lower surface 21 of the push-pull plate 2. Then, the IPA film is brought into contact with the front surface of the wafer W. With the IPA film kept in contact with the front surface of the wafer W, the deionized water adhering on the front surface of the wafer W is replaced with the IPA. Thus, the front surface of the wafer W is dried by the volatility of the IPA.

After a lapse of a predetermined replacement period (e.g., 30 seconds) from the start of the discharge of the IPA, the supply of the IPA from the outlet ports 22 of the push-pull plate 2 is stopped. Thereafter, the rotative driving mechanism 13 of the spin chuck 10 is rotatively driven to rotate the wafer W at a predetermined rotation speed (e.g., 100 rpm). Further, the nitrogen gas is discharged from the outlet ports 22 of the push-pull plate 2. The nitrogen gas discharged from the outlet ports 22 is sucked from the suction ports 23, and exhausted through the central suction pipe 41 into an exhaust system not shown. Thus, streams of the nitrogen gas flowing from the outlet ports 22 to the suction ports 23 are formed between the front surface of the wafer W and the lower surface 21 of the push-pull plate 2, whereby minute IPA droplets remaining on the front surface of the wafer W are speedily dried. In the IPA supply process, almost all the deionized water on the wafer W is removed. This eliminates the possibility that deionized water droplets are scattered around the wafer W even if the wafer W is rotated.

After a lapse of a predetermined drying period (e.g., 30 seconds) from the start of the discharge of the nitrogen gas, the supply of the nitrogen gas from the outlet ports 22 of the push-pull plate 2 is stopped. Further, the rotative driving of the rotative driving mechanism 13 of the spin chuck 10 is stopped, whereby the rotation of the wafer W is stopped. Thus, a process sequence for the treatment of the wafer W ends. Then, the treated wafer W is unloaded by the transport robot not shown.

According to the embodiment described above, the treatment liquid is discharged from the outlet ports 22 provided on the push-pull plate 2 toward the front surface of the wafer W and sucked from the suction ports 23 provided on the push-pull plate 2, whereby the film of the treatment liquid is formed on the lower surface 21 of the push-pull plate 2. Then, the treatment liquid film is brought into contact with the front surface of the wafer W with the push-pull plate 2 being positioned in opposed relation to the front surface of the wafer W, whereby the front surface of the wafer W is treated with the treatment liquid. The treatment liquid discharged from the outlet ports 22 of the push-pull plate 2 is sucked from the suction ports 23 immediately after the discharge. Therefore, the treatment liquid is not scattered around the wafer W even if the wafer W is rotated. This ensures proper treatment of the front surface of the wafer W with the treatment liquid, while suppressing the scattering of the treatment liquid around the wafer W.

Since the wafer W is rotated relative to the push-pull plate 2, the treatment liquid is evenly brought into contact with the entire front surface of the wafer W. Thus, the front surface of the wafer W is evenly treated with the treatment liquid.

While the embodiment of the present invention has been described, the present invention may be embodied in other ways. For example, the layout of the outlet ports 22 and the layout of the suction ports 23 on the push-pull plate 2 may be exchanged, so that a plurality of suction ports 23 (e.g., six suction ports 23) are located around each outlet port 22. In this case, the treatment liquid discharged from the outlet port 22 is distributed to the suction ports 23 located around the outlet port 22.

In the embodiment described above, the spin chuck 10 is of the vacuum suction type, but is not limited to the vacuum suction type. For example, a mechanical chuck may be employed, which is adapted to hold the wafer W generally horizontally with a peripheral surface of the wafer W held by a holding member thereof. Further, a roller-type chuck may be employed, which is adapted to hold the wafer W generally horizontally with the peripheral surface of the wafer W held by a plurality of rotative rollers.

Alternatively, a plate having substantially the same construction as the push-pull plate 2 may be employed to hold the rear surface of the wafer W by suction. More specifically, a gas such as nitrogen gas is discharged from outlet ports of the plate toward the rear surface of the wafer W and sucked from suction ports of the plate, whereby gas streams are formed on the plate to hold the wafer W by suction. In this case, a guide should be provided along the periphery of the plate to restrict the lateral movement of the wafer W.

In the embodiment described above, the wafer W is rotated relative to the stationary push-pull plate 2. Conversely, the relative rotation of the wafer W and the push-pull plate 2 may be achieved by keeping the wafer W stationary and rotating the push-pull plate 2 relative to the wafer W.

In the embodiment described above, the wafer W is generally horizontally held by the spin chuck 10 with its front surface up, and the liquid film retained by the push-pull plate 2 is brought into contact with the front surface of the wafer W from an upper side. The positional relationship between the wafer W and the push-pull plate 2 may be inverted. More specifically, the spin chuck 10 is positioned with the suction base 12 thereof facing downward, and the surface of the push-pull plate 2 formed with the outlet ports 22 and the suction ports 23 is opposed to the suction base 12 from a lower side. In this state, the wafer W is generally horizontally held by the spin chuck 10 with its front surface down, and then the liquid film retained by the push-pull plate 2 is brought into contact with the front surface of the wafer W from the lower side.

The wafer W or the push-pull plate 2 is not necessarily required to be rotated about an axis extending through the center thereof as in the embodiment described above. The wafer W or the push-pull plate 2 may be rotated (revolved) about an axis eccentric from the center thereof. In this case, the entire wafer W including a center portion thereof can be evenly treated with the treatment liquid.

While the present invention has been described in detail by way of the embodiment thereof, it should be understood that the embodiment is merely illustrative of the technical principles of the present invention but not limitative of the invention. The spirit and scope of the present invention are to be limited only by the appended claims.

This application corresponds to Japanese Patent Application No. 2006-235016 filed in the Japanese Patent Office on Aug. 31, 2006, the disclosure of which is incorporated herein by reference.

What is claimed is:

1. A substrate treatment apparatus comprising:
a substrate holding unit which holds a substrate;
a push-pull plate to be positioned in spaced opposed relation to one surface of the substrate held by the substrate holding unit, the push-pull plate having a plurality of outlet ports which discharge a treatment liquid and a plurality of suction ports which suck the treatment liquid discharged from the outlet ports, the outlet ports and the suction ports being provided in a surface of the push-pull plate to be opposed to the one surface of the substrate; and
a relative rotation unit which rotates the substrate held by the substrate holding unit and the push-pull plate relative to each other.

2. A substrate treatment apparatus as set forth in claim 1, wherein the relative rotation unit rotates the substrate held by the substrate holding unit about an axis extending through a center of the substrate.

3. A substrate treatment method comprising the steps of:
holding a substrate by a substrate holding unit;
positioning a push-pull plate in spaced opposed relation to one surface of the substrate held by the substrate holding unit, the push-pull plate having a plurality of outlet ports which discharge a treatment liquid and a plurality of suction ports which suck the treatment liquid discharged from the outlet ports, and bringing the treatment liquid discharged from the outlet ports into contact with the one surface of the substrate; and
rotating the substrate and the push-pull plate relative to each other in the liquid contacting step.
